(19) United States
(12) Patent Application Publication
(10) Pub. No.: US 2011/0103737 A1
(43) Pub. Date: May 5, 2011

(54) OPTICAL WIRING BOARD AND MANUFACTURING METHOD THEREOF

(75) Inventors: Joon-Sung KIM, Suwon-si (KR); Han-Seo Cho, Yusung-gu (KR); Jae-Hyun Jung, Ansan-si (KR); Sang-Hoon Kim, Goonpo-si (KR)

(73) Assignee: SAMSUNG ELECTRO-MECHANICS CO., LTD.

(21) Appl. No.: 12/761,752

(22) Filed: Apr. 16, 2010

(30) Foreign Application Priority Data
Nov. 2, 2009 (KR) 10-2009-0104771

(51) Int. Cl. G02B 6/12; B32B 37/00

(52) U.S. Cl. 385/14; 156/275.5

(57) ABSTRACT

An optical wiring board and a manufacturing method thereof are disclosed. In accordance with an embodiment of the present invention, the method includes providing a base substrate having a wiring groove formed therein, forming a first clad layer by filling a first clad substance in the wiring groove, stacking an intermediate insulating layer on the base substrate, in which the intermediate insulating layer has a through-hole formed therein and the through-hole corresponds to the wiring groove, forming a core unit on the first clad layer, forming a second clad layer by filling a second clad substance in the through-hole, in which the second clad layer covers the core unit, and stacking a cover insulting layer on the intermediate insulating layer, in which the cover insulating layer covers the second clad layer.

### CROSS-REFERENCE TO RELATED APPLICATIONS

This application claims the benefit of Korean Patent Application No. 10-2009-0104771, filed with the Korean Intellectual Property Office on Nov. 2, 2009, the disclosure of which is incorporated herein by reference in its entirety.

### BACKGROUND

1. Technical Field

The present invention is related to an optical wiring board and a manufacturing method thereof.

2. Description of the Related Art

Due to the high speed and large capacity of data processed in electronic components, the conventional printed circuit board technology using copper-based electrical wiring patterns has reached its limit. In order to overcome the problems of the conventional copper-based electrical wiring patterns, optical wiring boards including optical wiring are recently receiving attention.

In the optical wiring board, the optical wiring that can transmit and receive signals through light by using polymers and optical fibers is inserted in a printed circuit board, and this is referred to as an electro-optical circuit board (EOCB). The EOCB is commonly employed in switches and transceiving devices of a communication network, switches and servers for data communication, communication for the aerospace industry and the avionics, mobile phone base stations of a universal mobile telecommunication system (UMTS) and the backplane and daughter board of a super computer.

The optical wiring is commonly formed by being embedded in a substrate during the stacking process of a multi-layered printed circuit board. The optical wiring is made of polymers having a high optical transmittance and constituted by a core unit, which has a rectangular cross-section with the thickness of about 50 um and in which signals are actually propagated, and a clad layer, which surrounds the core unit.

In the conventional technology, however, the core unit is formed by patterning a core layer after the core layer is formed by coating a core substance on the front surface of a substrate, thus wasting the expensive core substance. Moreover, the clad layer surrounding the core unit is also processed after it is coated and formed on the front surface of the substrate, thus wasting the expensive clad substance.

Furthermore, when the optical wiring board is bent or twisted, a crack may easily occur in the interface between the clad layer and an insulating layer.

### SUMMARY

The present invention provides an optical wiring board and a method of manufacturing the same that can minimize unnecessary core substance consumption.

The present invention also provides an optical wiring board that is very durable against bending or twisting and a method of manufacturing the same.

An aspect of the present invention provides a method of manufacturing an optical wiring board that includes providing a base substrate having a wiring groove formed therein, forming a first clad layer by filling a first clad substance in the wiring groove, stacking an intermediate insulating layer on the base substrate, in which the intermediate insulating layer has a through-hole formed therein and the through-hole corresponds to the wiring groove, forming a core unit on the first clad layer, forming a second clad layer by filling a second clad substance in the through-hole, in which the second clad layer covers the core unit, and stacking a cover insulting layer on the intermediate insulating layer, in which the cover insulating layer covers the second clad layer.

The forming of the first clad layer can include filling a first clad substance in the wiring groove, flattening the filled first clad substance and hardening the filled first clad substance.

The flattening of the first clad substance can include pressing the first clad substance filled in the wiring groove with a light-permeable plate-shaped member, and the hardening of the first clad substance can include exposing the first clad substance filled in the wiring groove to light and removing the plate-shaped member.

The forming of the core unit can include filling a core substance in the through-hole, flattening the filled core substance and hardening the filled core substance.

The flattening of the core substance can include pressing the core substance filled in the through-hole with a light-permeable plate-shaped member, and the hardening of the core substance can include selectively exposing the core substance filled in the through-hole to light by using a mask in which a pattern corresponding to a shape of the core unit is formed and removing the plate-shaped member and developing the exposed core substance.

The forming of the core unit can further include patterning the hardened core substance by using a laser. The forming of the second clad layer can include filling a second clad substance in the through-hole, flattening the filled second clad substance and hardening the filled second clad substance.

The flattening of the second clad substance can include pressing the second clad substance filled in the through-hole with a light-permeable plate-shaped member, and the hardening of the second clad substance can include exposing the second clad substance filled in the through-hole to light and removing the plate-shaped member.

The providing of the base substrate can include forming a penetrated wiring hole on a base insulating layer and stacking the base insulating layer on a base layer.

Another aspect of the present invention provides an optical wiring board that includes a base substrate having a wiring groove formed therein, a first clad layer, which is formed in the wiring groove, an intermediate insulating layer, which is stacked on a first insulating layer and in which the intermediate insulating layer has a through-hole formed therein and the through-hole corresponds to the wiring groove, a core unit, which is formed in the through-hole and stacked on the first clad layer, a second clad layer, which is formed in the through-hole and in which the second clad layer covers the core unit, and a cover insulating layer, which is stacked on the intermediate insulating layer and in which the cover insulating layer covers the second clad layer.

The base substrate can include a base layer and a base insulating layer, which is stacked on the base layer and has a penetrated wiring hole formed therein.

The first clad layer can be formed with a thickness that corresponds to a depth of the wiring groove.

The core unit can include a plurality of core patterns.

The base substrate can include a light-permeable unit that is shaped to correspond to the wiring groove.

The cover insulating layer can include a penetrated opening, and the optical wiring board can further include a mirror unit that is shaped to correspond to the opening.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flow diagram illustrating a method of manufacturing an optical wiring board in accordance with an embodiment of the present invention.

FIGS. 2 to 15 are cross-sectional views illustrating a method of manufacturing an optical wiring board in accordance with an embodiment of the present invention.

FIGS. 16 and 17 are cross-sectional views of an optical wiring board in accordance with an embodiment of the present invention.

FIG. 18 is a cross-sectional view of an optical wiring board in accordance with another embodiment of the present invention.

### DETAILED DESCRIPTION

An optical wiring board and a method of manufacturing the optical wiring board according to certain embodiments of the present invention will be described below in more detail with reference to the accompanying drawings.

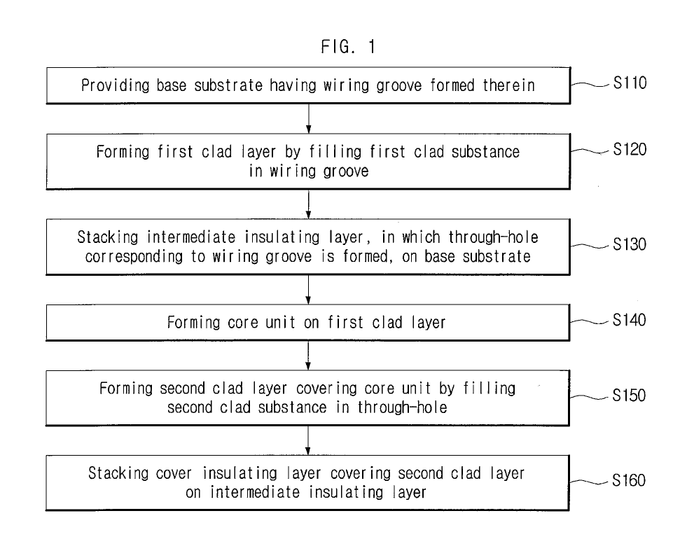

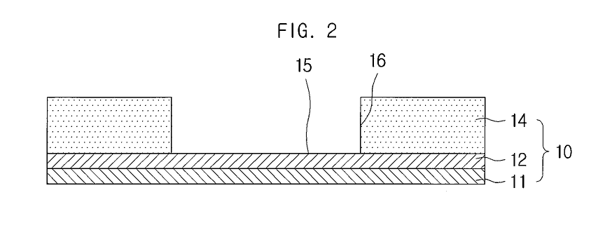

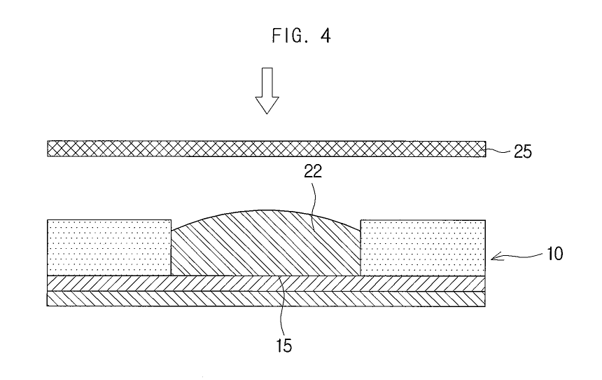

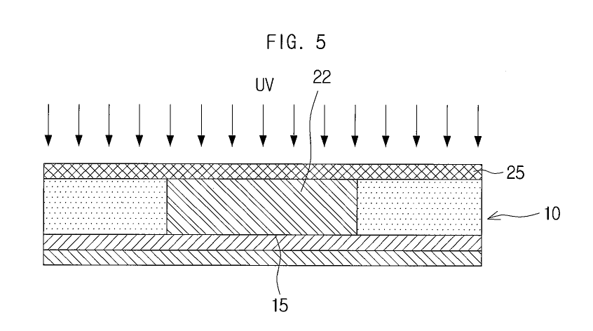

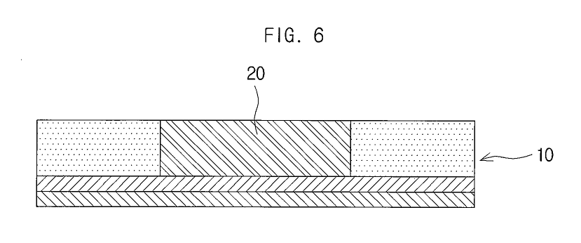

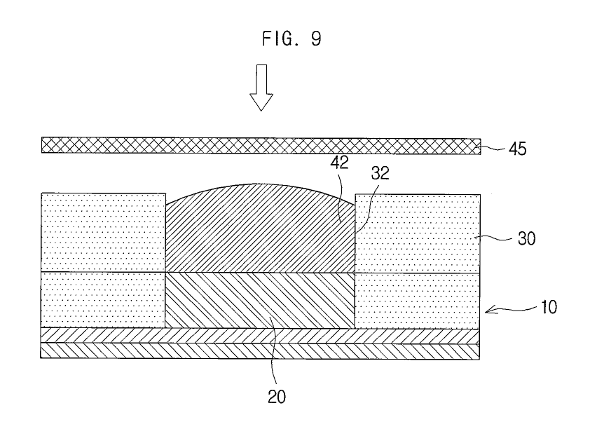

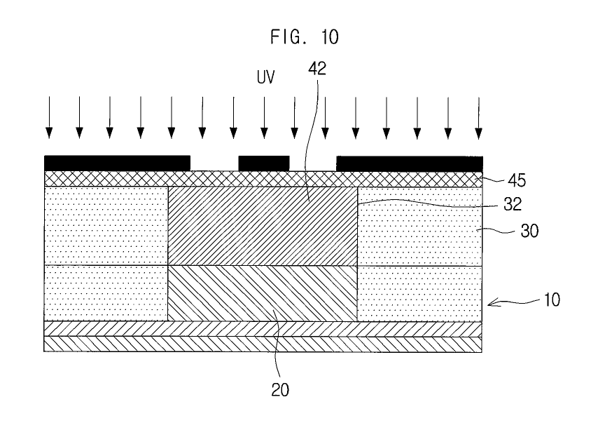

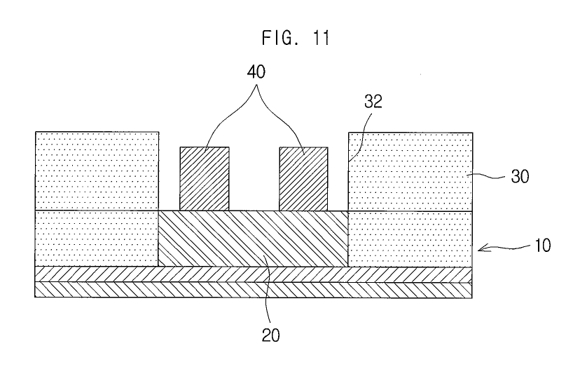

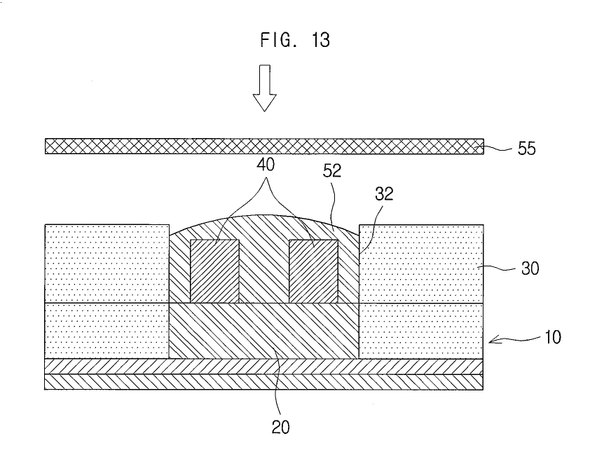

FIG. 1 is a flow diagram illustrating a method of manufacturing an optical wiring board in accordance with an embodiment of the present invention, and FIGS. 2 to 15 are cross-sectional views illustrating a method of manufacturing an optical wiring board in accordance with an embodiment of the present invention.

A method of manufacturing an optical wiring board in accordance with an embodiment of the present invention includes providing a base substrate (S110), forming a first clad layer (S120), stacking an intermediate insulating layer (S130), forming a core unit (S140), forming a second clad layer (S150) and stacking a cover insulating layer (S160).

In the providing of the base substrate (S110), a base substrate 10, in which a wiring groove 15 is formed, is provided. The wiring groove 15 forms a space in which a first clad substance 22, which will be described later, is filled, and can be shaped to correspond to a portion in which an optical wiring is formed. As such, since the first clad substrate 22 is filled in the wiring groove 15 only, unnecessary consumption of the first clad substance 22 can be prevented in the process of forming a first clad layer 20.

In this embodiment, as illustrated in FIG. 2, after a through-hole shaped wiring hole 16 is formed in a base insulating layer 14, the base substrate 10 can be formed by stacking the base insulating layer 14 on a base layer 12. Accordingly, the wiring groove 15 that is surrounded by the base layer 12 and the inner wall of the wiring hole 16 can be formed. As a result, the inner wall of the wiring groove 15 can be formed smooth, and no pollutant can be left inside the wiring groove 15, thereby preventing the first clad layer 20 from contamination or damage. However, this is not intended to limit the forming of the base substrate 10 and the wiring groove 15 to this embodiment, and the base substrate 10 and the wiring groove 15 can be formed by other various known methods.

In the forming of the first clad layer (S120), the first clad layer 20 is formed by filling the first clad substance 22 in the wiring groove 15. By adjusting the depth of the wiring groove 15 or the filling amount of the first clad substance 22, the thickness of the first clad layer 20 can be easily adjusted. Particularly, since the first clad layer 20 is formed by filling the first clad substance 22 in a groove structure, the first clad layer 20 having a desired thickness can be formed.

Here, the first clad substance 22 can be made of a material of polymer series including acryl, epoxy, polyimide, etc.

Furthermore, the first clad substance 22 can be made of a liquid material, and the liquid-state first clad substance 22 can be filled by various methods such as dispensing, ink jetting and printing.

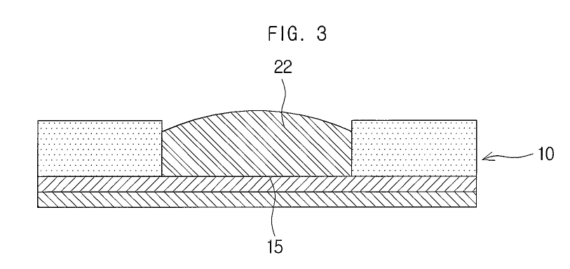

In this embodiment, as illustrated in FIGS. 3 to 6, after the first clad substance 22 is filled in the wiring groove 15, the filled first clad substance 22 is flattened and hardened to form the first clad layer 20. Since the first clad substance 22 filled in the wiring groove 15 can be evenly distributed with a uniform thickness by the flattening process, the first clad layer 20 can be formed with a uniform thickness.

Specifically, while the first clad substance 22 filled in the wiring groove 15 is flattened by being pressed by a light-permeable plate-shaped member 25, the first clad substance 22 filled in the wiring groove 15 can be hardened by being exposed to light such as ultraviolet rays through the light-permeable plate-shaped member 25. In this way, the flattening and hardening processes can be performed at the same time, thereby simplifying the overall manufacturing process.

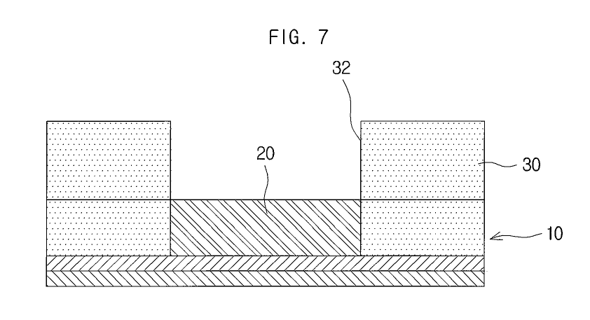

In the stacking of the intermediate insulating layer (S130), an intermediate insulating layer 30, in which a through-hole 32 corresponding to the wiring groove 15 is formed, is stacked on the base substrate 10. That is, as illustrated in FIG. 7, the through-hole 32, which is connected to the wiring groove 15, is disposed on the wiring groove 15.

The through-hole 32 of the intermediate insulating layer 30 forms a space in which a core unit 40 can be disposed. Accordingly, by filling a core substance 42 in the through-hole 32 only, unnecessary waste of the core substance 42 can be prevented during the forming of the core unit 40.

In the forming of the core unit (S140), the core unit 40 is formed on the first clad layer 20 that is exposed through the through-hole 32. The core unit 40 is a path through which an optical signal is transferred and has a higher refractive index than the first clad layer 20 and a second clad layer 60, which will be described later, for efficient optical signal transmission.

In this embodiment, the core unit 40 is formed by filling the core substance 42 in the through-hole 32. Accordingly, by adjusting the thickness of the intermediate insulating layer 30 or the filling amount of the core substance 42, the thickness of the core unit 40 can be readily adjusted. Particularly, since the core unit 40 is formed by filling the core substance 40 in a groove structure, the core unit 40 having a desired thickness can be formed.

Here, the core substance 42 is made of a material of polymer series that is similar to that of the first clad substance 22, and can be filled by the known methods described above.

In this embodiment, after the core substance 42 is filled in the through-hole 32, the filled core substance 42 can be flattened and hardened to form the core unit 40. Since the core substance 42 filled in the through-hole 32 is evenly distributed with a uniform thickness by the flattening process, the core unit 40 can be formed with a uniform thickness.

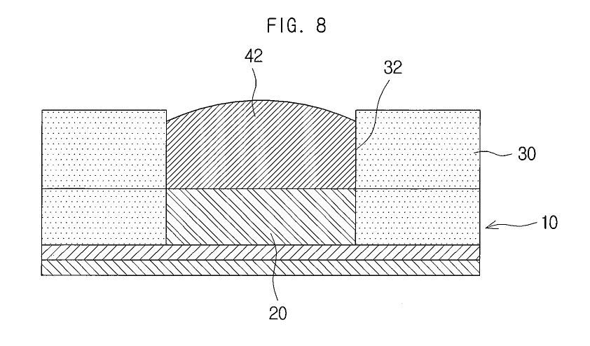

Specifically, as illustrated in FIGS. 8 to 11, while the core substance 42 filled in the through-hole 32 is flattened by being pressed by a light-permeable plate-shaped member 45, the core substance 42 can be hardened by being selectively exposed to light such as ultraviolet rays by using a mask in which a pattern corresponding to the shape of the core unit 40 is formed. Then, by removing the plate-shaped member 45 and developing the exposed core substance 42, the core unit 40 having a desired shape can be formed. In this way, the flattening and hardening processes can be performed at the same time, thereby simplifying the overall manufacturing process.

Here, the core unit 40 can be formed to have a lower height than the depth of the through-hole 32 in order to form a second clad layer 50, which will be described later.

In another example, after the core substance 42 filled in the through-hole 32 is hardened, the hardened core substance 42 can be selectively patterned by using a laser to form the core unit 40 having a desired shape.

In the forming of the second clad layer (S150), the second clad layer 50 covering the core unit 40 is formed by filling the second clad substance 52 in the through-hole 32. Accordingly, by adjusting the depth of the through-hole 32 or the filling amount of the second clad substance 52, the thickness of the second clad layer 50 can be readily adjusted. Particularly, since the second clad layer 50 is formed by filling the second clad substance 52 in a groove structure, the second clad layer 50 having a desired thickness can be formed.

Here, the second clad substance 52 is made of a material of polymer series that is similar to that of the first clad substance 22, and can be filled by the known methods described above.

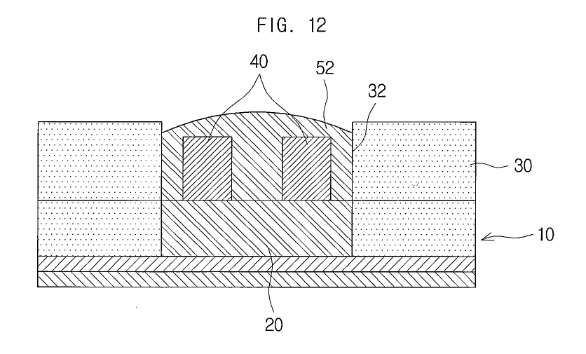

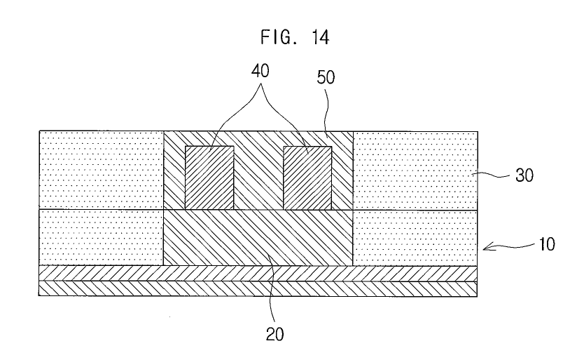

In this embodiment, as illustrated in FIGS. 12 and 14, after the second clad substance 52 is filled in the through-hole 32, the filled second clad substance 52 is flattened and hardened to form the second clad layer 50. Since the second clad substance 52 filled in the through-hole 32 is evenly distributed with a uniform thickness by the flattening process, the second clad layer 50 can be formed with a uniform thickness.

Specifically, while the second clad substance 52 filled in the through-hole 32 is flattened by being pressed by a light-permeable plate-shaped member 55, the second clad substance 52 filled in the through-hole 32 can be hardened by being exposed to light such as ultraviolet rays through the light-permeable plate-shaped member 55. In this way, the flattening and hardening processes can be performed at the same time, thereby simplifying the overall manufacturing process.

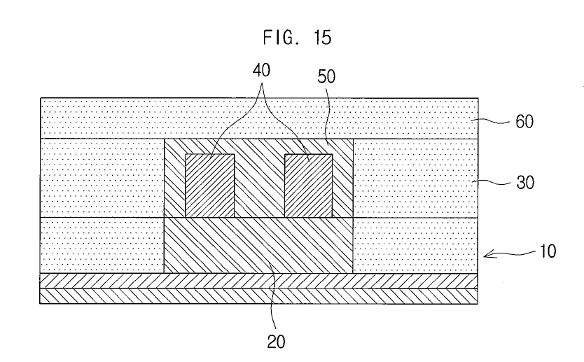

In the stacking of the cover insulating layer (S160), as illustrated in FIG. 15, the cover insulating layer 60 covering the second clad layer 50 is stacked on the intermediate insulating layer 30. With this arrangement, both the first clad layer 20 and the second clad layer 50 can be surrounded by the insulating layers 10, 30 and 60, and thus, when the optical wiring board is bent or twisted, the possibility of crack being occurred in an interface between the clad layers 20 and 50 and the insulating layers 10, 30 and 60 can be prevented.

An optical wiring board in accordance with certain embodiments of the present invention will be described below in more detail with reference to the accompanying drawings.

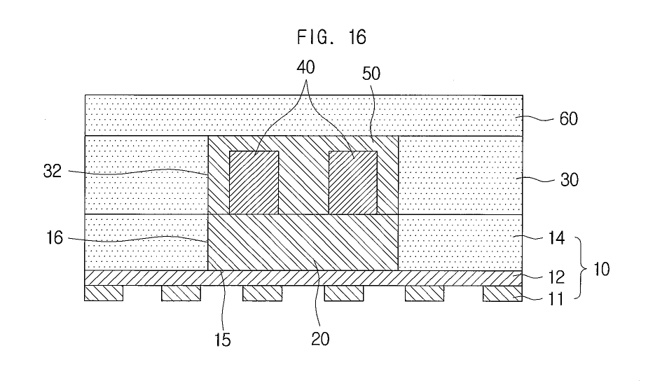

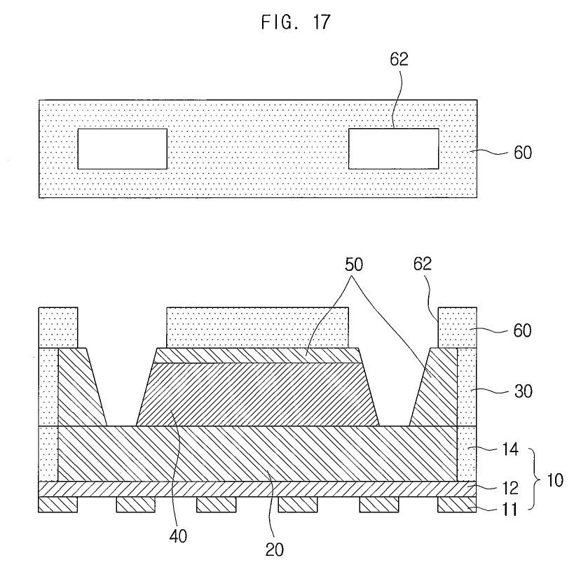

FIGS. 16 and 17 are cross-sectional views of an optical wiring board in accordance with an embodiment of the present invention.

An optical wiring board in accordance with an embodiment of the present invention includes a base substrate 10, a first clad layer 20, an intermediate insulating layer 30, a core unit 40, a second clad layer 50 and a cover insulating layer 60.

The base substrate 10 accommodates the first clad layer 20, which will be described later. For this, a wiring groove 15 is formed in the base substrate 10. In this embodiment, the first clad layer 20 is formed in the wiring groove 15 only, thus preventing unnecessary waste of the first clad substance 22.

Specifically, in the present embodiment, a base insulating layer 14 having a penetrated wiring hole 16 is stacked on a base layer 12 to form the base substrate 10 having the wiring groove 15 formed therein. Accordingly, the wiring groove 15 that is surrounded by the inner wall of the wiring hole 16 and the base layer 12 can be formed. With this arrangement, the inner wall of the wiring groove 15 can be formed smooth, and no pollutant can be left inside the wiring groove 15, thereby preventing the first clad layer 20 from contamination or damage.

To allow an optical signal to pass through the base substrate 10, the base substrate 10 can include a light-permeable unit (not shown) that is shaped to correspond to the position of the wiring groove 15 in which an optical wiring pattern is disposed.

Also formed in the base substrate 10 can be a circuit pattern 11 that is needed for transmitting an electrical signal.

Together with the second clad layer 60, which will be described later, the first clad layer 20 prevents an optical signal transferred through the core unit 40 from leaking and covers the core unit 40 together with the second clad layer 60.

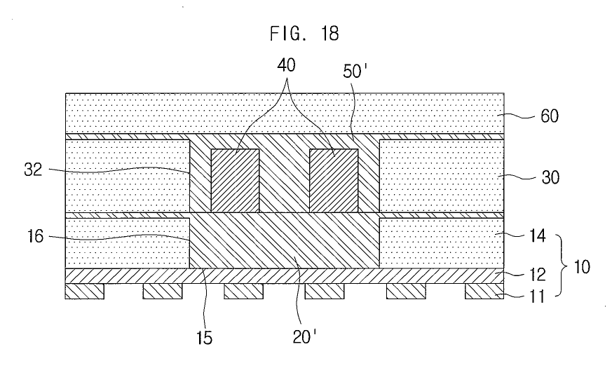

Since the first clad layer 20 of this embodiment is formed by being filled in the wiring groove 15, the first clad layer 20 having a desired thickness can be formed. Accordingly, the first clad layer 20 can be formed with a thickness that corresponds to the depth of the wiring groove 15. This, however, is by no means to restrict the thickness of the first clad layer 20 to be the same as the depth of the wiring groove 15, and the first clad layer 20 can also be formed thicker than the depth of the wiring groove 15, as illustrated in FIG. 18.

Furthermore, the first clad layer 20 can be made of a material of polymer series including acryl, epoxy, polyimide, etc.

The intermediate insulating layer 30 accommodates the core unit 40, which will be described later. For this, a through-hole 32 corresponding to the wiring groove 15 is formed in the intermediate insulating layer 30. In this embodiment, the core unit 40 is formed in the through-hole 32 only, thus preventing unnecessary waste of the core substance 42.

The core unit 40 is a path through which an optical signal is transferred and can have a higher refractive index than the first clad layer 20 and the second clad layer 60, which will be described later, for efficient optical signal transmission. Since the core unit 40 of the present embodiment is stacked on the first clad layer 20 inside the first through-hole 32, the core unit 40 having a desired thickness can be formed.

Here, the core unit 40 can be made of a material of polymer series that is similar to that of the first clad layer 20.

Also, since the core unit 40 is formed with a certain pattern, it can include a plurality of core patterns and transfer a plurality of optical signals.

Together with the first clad layer 20, the second clad layer 50 prevents an optical signal transferred through the core unit 40 from leaking and covers the core unit 40 together with the first clad layer 20.

The second clad layer 50 of this embodiment is formed by being filled in the through-hole 32 so as to cover the core unit 40, and thus the second clad layer 50 having a desired thickness can be formed. Accordingly, the second clad layer 50 can be formed with a thickness that corresponds to the depth of the through-hole 32. This, however, is by no means to restrict the thickness of the second clad layer 50 to be the same as the depth of the through-hole 32, and the second clad layer 50 can also be formed thicker than the depth of the through-hole 32, as illustrated in FIG. 18.

Here, the second clad layer 50 can be made of a material of polymer series that is similar to that of the first clad layer 20.

The cover insulating layer 60 is a part that covers the second clad layer 50. For this, the cover insulating layer 60 is stacked on the intermediate insulating layer 30. With this arrangement, both the first clad layer 20 and the second clad layer 50 can be surrounded by the insulating layers 10, 30 and 60, and thus, when the optical wiring board is bent or twisted, the possibility of crack being occurred in an interface between the clad layers 20 and 50 and the insulating layers 10, 30 and 60 can be prevented.

As illustrated in FIG. 17, an opening 62 is formed in the cover insulating layer 60, and a mirror unit can be formed in the optical wiring board through the opening 62.

In one possible embodiment of the present invention, a core substance and a clad substance can be filled only in a groove-shaped portion where a core unit and a clad layer are to be formed, thus preventing unnecessary waste of the core substance and the clad substance.

Furthermore, since a clad layer is surrounded by an insulating layer, the possibility of crack being occurred in the interface between the clad layer and the insulating layer can be prevented.

While the spirit of the present invention has been described in detail with reference to particular embodiments, the embodiments are for illustrative purposes only and shall not limit the present invention. It is to be appreciated that those skilled in the art can change or modify the embodiments without departing from the scope and spirit of the present invention.

As such, many embodiments other than those set forth above can be found in the appended claims.

What is claimed is:

1. A method of manufacturing an optical wiring board, the method comprising:
providing a base substrate having a wiring groove formed therein;
forming a first clad layer by filling a first clad substance in the wiring groove;
stacking an intermediate insulating layer on the base substrate, the intermediate insulating layer having a through-hole formed therein, the through-hole corresponding to the wiring groove;
forming a core unit on the first clad layer;
forming a second clad layer by filling a second clad substance in the through-hole, the second clad layer covering the core unit; and
stacking a cover insulting layer on the intermediate insulating layer, the cover insulating layer covering the second clad layer.

2. The method of claim 1, wherein the forming of the first clad layer comprises:
filling a first clad substance in the wiring groove;
flattening the filled first clad substance; and
hardening the filled first clad substance.

3. The method of claim 2, wherein:
the flattening of the first clad substance comprises pressing the first clad substance filled in the wiring groove with a light-permeable plate-shaped member; and
the hardening of the first clad substance comprises:
exposing the first clad substance filled in the wiring groove to light; and
removing the plate-shaped member.

4. The method of claim 1, wherein the forming of the core unit comprises:
filling a core substance in the through-hole;
flattening the filled core substance; and
hardening the filled core substance.

5. The method of claim 4, wherein:
the flattening of the core substance comprises pressing the core substance filled in the through-hole with a light-permeable plate-shaped member; and
the hardening of the core substance comprises:
selectively exposing the core substance filled in the through-hole to light by using a mask in which a pattern corresponding to a shape of the core unit is formed; and
removing the plate-shaped member and developing the exposed core substance.

6. The method of claim 4, wherein the forming of the core unit further comprises patterning the hardened core substance by using a laser.

7. The method of claim 1, wherein the forming of the second clad layer comprises:
filling a second clad substance in the through-hole;
flattening the filled second clad substance; and
hardening the filled second clad substance.

8. The method of claim 7, wherein:
the flattening of the second clad substance comprises pressing the second clad substance filled in the through-hole with a light-permeable plate-shaped member; and
the hardening of the second clad substance comprises:
exposing the second clad substance filled in the through-hole to light; and
removing the plate-shaped member.

9. The method of claim 1, wherein the providing of the base substrate comprises:
forming a penetrated wiring hole on a base insulating layer; and
stacking the base insulating layer on a base layer.

10. An optical wiring board comprising:
a base substrate having a wiring groove formed therein;
a first clad layer formed in the wiring groove;
an intermediate insulating layer stacked on a first insulating layer, the intermediate insulating layer having a through-hole formed therein, the through-hole corresponding to the wiring groove;
a core unit formed in the through-hole and stacked on the first clad layer;
a second clad layer formed in the through-hole, the second clad layer covering the core unit; and
a cover insulating layer stacked on the intermediate insulating layer, the cover insulating layer covering the second clad layer.

11. The optical wiring board of claim 10, wherein the base substrate comprises:
a base layer; and
a base insulating layer stacked on the base layer and having a penetrated wiring hole formed therein.

12. The optical wiring board of claim 10, wherein the first clad layer is formed with a thickness that corresponds to a depth of the wiring groove.

13. The optical wiring board of claim 10, wherein the core unit comprises a plurality of core patterns.

14. The optical wiring board of claim 10, wherein the base substrate comprises a light-permeable unit that is shaped to correspond to the wiring groove.

15. The optical wiring board of claim 10, wherein the cover insulating layer comprises a penetrated opening, and
the optical wiring board further comprises a mirror unit that is shaped to correspond to the opening.
